(19) United States
(12) Patent Application Publication
(10) Pub. No.: US 2006/0010165 A1
(43) Pub. Date: Jan. 12, 2006

(54) Collaboration via spreadsheets for planning

(76) Inventor: Karen A. Gee, Heidelberg (DE)

Correspondence Address: KENYON & KENYON, ONE BROADWAY, NEW YORK, NY, 10004, US

(21) Appl. No.: 11/080,013

(22) Filed: Mar. 14, 2005

Related U.S. Application Data
(60) Provisional application No. 60/585,594, filed on Jul. 7, 2004.

(51) Int. Cl. G06F 17/00

(52) U.S. Cl. 707/104.1

(57) ABSTRACT

Collaborating planning information includes retrieving previous planning information, such as planning information from a planning information database. The collaboration of planning information further includes generating an output form including output planning information using a collaborative workspace. Furthermore, missing planning information, including previous planning information, current planning information and/or projected planning information, is determined and an end user is notified. The current and projected planning information may be integrated with existing planning data through the collaborative workspace. The full data set may be stored in the planning information database and accessible using the collaborative workspace.

### BACKGROUND

The present invention relates generally to the area of software and more specifically to the integration and collaboration of information.

Currently, problems arise in maintaining effective records of planning information. For example, with volumes of planning information, it is easy to overlook certain missing information, such as with an example of the planning information being sales information, sales information from a specific salesperson for a specific sales items may be accidentally omitted. In the example of sales teams with multiple sales associates, team members may be at different physical locations or in transit, and not in a central workplace. Gathering information from individual team members therefore requires more communications and reminders and required information input may be easily overlooked. Also, it may be extremely time consuming to actively and manually track and remember each team member's input. Incomplete information prevents a system from generating effective sales models and properly assessing the activities and efficiencies of the sales staff, as well as the status of product lines being sold.

One common approach to tracking sales data is entering the sales information in a standard spreadsheet application. This approach typically entails multiple steps to coordinate the requested data and provides limited usefulness with the acquired data. Even though current techniques utilize electronic forms to acquire the information, the current systems fail to integrate the acquired data for providing the acquired data for various modeling operations.

A common approach includes assembling and documenting prior years' sales figures. These sales figures are then entered into a recording device, such as the spreadsheet application. Moreover, when dealing with previous generation spreadsheet applications, the tracking of sales updates may need to be done manually. Furthermore, previous generation spreadsheet applications may not enable users to pre-define logical connections between information from a database, which should be populated in the spreadsheet. Discussions take place with each salesperson or sales team to determine sales goals for an upcoming period. The projected sales numbers are then also entered into the recording device, such as the same spreadsheet application. After a period of time, current sales numbers are collected and once again entered into the spreadsheet application.

Therefore, the spreadsheet application includes multiple columns of data representing historic, planned, actual and/or forecasted numbers. Within the application, previous sales information can be visually compared with the projected sales data and the current sales data. This approach is limited since all of the above collection efforts and data entry are limited to the specific spreadsheet application. Under current approaches, if a user attempts to perform further analysis of the information, the user must manually re-enter the information into another spreadsheet application or import this information into a database or application which uses a database. This approach is thereupon error prone due to the potential of improper data re-entry. As collaboration with the spreadsheet is performed on an ad-hoc basis and changes are manually tracked, this approach is also error prone.

Other problems arise regarding the access to data for data input and review. Different systems operate on different platforms, which require aggregation of information from different applicant databases for interoperability. For example, one system may include financial data for previous sales data and customer resource management may contain the projected sales information. A database application which aggregates required data from multiple databases or information sources may be needed to aggregate the data between the software applications. Therefore, a user may be required to purchase and operate all the different software applications to achieve sales information collaboration, based on varying levels of interoperability and compatibility. The user may also be required to define one or more queries/rules used to extract the appropriate data from the one or multiple databases or information sources. Even though the sales information collaboration is across multiple platforms, needing translation for usability requires extra software applications just for comparing the data. These systems have limited interactivity and require the user to directly access the specific application, preventing offline activity. Therefore problems arise in sales data collection. Other drawbacks of prior implementations include requiring all team participants to login and navigate to an appropriate place in the application to input information, which may require multiple menus and/or submenus. The user may not successfully navigate to the correct place in the application to input data, or they may not understand the application user interface.

### BRIEF DESCRIPTION OF THE DRAWINGS

FIG. 1 illustrates a block diagram of one embodiment of a system for collaborating information;

FIG. 2 illustrates a block diagram of a portion of one embodiment of a system for collaborating information;

FIG. 3 illustrates a block diagram of another portion of one embodiment of a system for collaborating information;

FIG. 4 illustrates a block diagram of another embodiment of a system for collaborating information;

FIG. 5 illustrates a flowchart of the steps of one embodiment of a method for collaborating information;

FIG. 6 illustrates a flowchart of the steps of another embodiment of a method for collaborating information;

FIG. 7 illustrates a flowchart of the steps of another embodiment of a method for collaborating information;

FIG. 8 illustrates a flowchart of the steps of another embodiment of a method for collaborating information; and

FIG. 9 illustrates a flowchart of the steps of another embodiment of a method for collaborating information.

### DETAILED DESCRIPTION

The collaboration of information, such as planning information, allows for a greater degree of accessibility and usability of the information. Through the integration of information storage systems, data retrieval systems and data acquisition systems, the breadth and completeness of planning information may be improved. Through the use of a collaborative workspace environment, data acquisition is simplified and streamlined, where the collaborative workspace is a central user interface allowing for multi-user access to multiple levels of information. Using the collaborative workspaces allows multi-user access and the multiple levels of information from varying protocols or formats. Furthermore, users are allowed to utilize a portable and document-based application and using the application for processing activities, such as calculations, formatting and planning activities. Moreover, the document-based application provides embedded descriptions of the data to be populated into the cells of the spreadsheet, such as metadata. These embedded descriptions may not be visible to the user, but allow for backend support for various data manipulation operations, including database querying. The document-based application may also provide for defining cell attributes, which would allow for resizing of columns, fonts and other visible attributes to aid in readability and printing of subsequent documentation.

In one exemplary embodiment, the planning information may be directed to sales information, wherein the collaboration allows for the automatic generation of notifications to team members based on various predefined rules. These notifications, may then be submitted to the parties having the sales information, through any suitable communication format such as but not limited to electronic mail, instant messaging, telephony and other communication channels available from the collaborative workspace. The information collaboration is further assisted through the direct integration of updated sales information using the missing sales data forms. Although, the planning information may be directed to any suitable type of information used for planning purposes including multiple users providing varying input data factors across a central collaborative workspace, such as but not limited to product planning and procurement planning.

The collaboration of sales information not only thereby allows for easier management of the sales information, but also allows quick and direct access to the sales information. Whereas prior systems included sales information stored in different systems, requiring the end user to physically aggregate the information if the systems were not compatible, the sales information collaboration of the present invention allows for automatic assembly of information. The information acquired from the database may include metadata defining particular fields, where the meta-data may be formatted in an extensible mark-up language. Moreover, through searching and filtering functions, specific sales information may be extracted for data analysis, seamlessly using all different types of sales information from different sources through a central processing system.

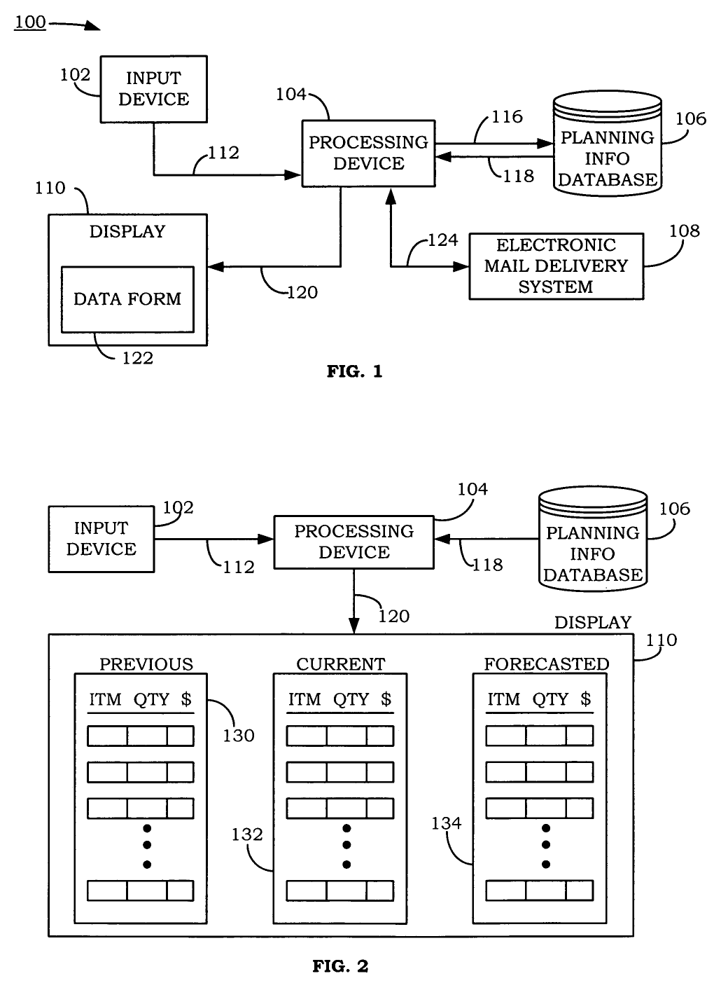

More specifically, FIG. 1 illustrates one exemplary embodiment of a system 100 providing for the collaboration of information using the exemplary embodiment of sales information. The system 100 includes an input device 102, a processing device 104, a planning information database 106, an electronic mail delivery system 108 and a display 110. The input device 102 may be any suitable device, such as, but not limited to, a keyboard, a keypad, a touch screen, a personal digital assistant, a mobile computing device or a networked computing device operative to provide an input signal 112.

The processing device 104 operates in response to executable instructions, providing the collaborative workspace in response to the associated programming instructions. The collaborative workspace allows multi-user access to planning information through a central processing device or system executing processing instructions. The collaborative workspace allows for the interaction of various forms and data between different users and platforms. In other words, a collaborative workspace may be a central access software application allowing multiple users to access one or more databases of information, where the collaborative workspace further includes instructions to perform data manipulation operations on the data passed therethrough, for data retrieval and data entry operations. In one embodiment, the collaborative workspace may be the NetWeaver Collaborative Rooms available from SAP. The collaborative workspace allows for, in one embodiment, the publication of information, tracking changes made to the information and assigning responsibility for the data entry of the information.

The processing device 104 may be, but not limited to, a single processor, a plurality of processors, a DSP, a microprocessor, an ASIC, a state machine, or any other implementation capable of processing and executing software. The term processing device should not be construed to refer exclusively to hardware capable of executing software and may implicitly include DSP hardware, ROM for storing software, RAM, and any other volatile or non-volatile storage medium. The planning information database 106 may be any suitable memory or storage location operative to store sales information or any other suitable information therein including, but not limited to, a single memory, a plurality of memory locations, shared memory, CD, DVD, ROM, RAM, EEPROM, optical storage, microcode, or any other non-volatile storage capable of storing information.

In the exemplary embodiment of the planning information database and information collaboration being direct to sales information, previous sales data is stored in the planning information database 106. The previous sales data may be, but not limited to, pricing, quantity, date(s) of sale, buyer, salesperson, delivery date(s) or any other suitable data relating to sales as recognized by one having ordinary skill in the art.

In one embodiment, the processing device 104 may request the previous planning data, which in the exemplary embodiment of sales data may be previous sales data, from the planning information database 106 using a data retrieval request 116. For example, the data retrieval request 116 may be an SQL search request accessing the planning information database 106. In response thereto, requested previous sales data 118 is received by the processing device 104, wherein the request 116 and the data 118 may be transmitted using any suitable data transmission technique across any suitable network, such as but not limited to a local area network, a wireless network, a secured internet-based network connection or a proprietary network. The previous planning data may be any historical data used for planning purposes. Moreover, the requested previous sales data 118 may also include embedded meta-data that may be used to describe the contents of data fields.

The processing device 104 receives the requested previous sales data 118. Thereupon, the processing device 104 providing the collaborative workspace thereon, performs a data manipulation operation. The data manipulation operation may include a filtering operation, a masking operation, a security operation, a data modeling operation or any other suitable data manipulation operation as recognized by one having ordinary skill in the art.

The processing device 104 performs the data manipulation operation on the previous sales data to generate output planning data, wherein within the exemplary embodiment of sales data, the output planning data may be output sales data. The output sales data may be the resultant of the data manipulation operation, such as in one exemplary embodiment, filtering the previous sales data based on a particular date range. The output sales data would then be the previous sales data falling within the prescribed date range.

In one embodiment, the processing device 104 may thereupon convert the output sales data into a viewable data signal 120 to be provided to the display 110. As illustrated in FIG. 1, the display 110 may include a data form 122 having viewable data of the viewable data signal 120 displayed therein. For example, the data form 122 may be a screen on a computer monitor and the output sales data populates corresponding data fields, as discussed in further detail with respect to FIG. 2.

In one embodiment, the processing device 104 may also convert the output sales data into transmittable data 124 to be provided to the electronic mail delivery system. While the typical electronic mail delivery system 108 includes electronic mail (email), the electronic mail delivery system 108 may also include, but not limited to, messaging systems such as short messaging systems (SMS), extended messaging systems (EMS), multi-modal messaging systems (MMS), paging systems, cellular and other wireless communication systems.

The electronic mail delivery system 108 may transmit the output sales data in accordance with known electronic message techniques. In one embodiment, the processing device 104 may convert the output sales data into a format consistent with the electronic mail delivery system 108 such that the output sales data may be embedded within a message. In another embodiment, the processing device 104 may convert the output sales data into a format independent of the electronic mail delivery system 108 such that the output sales data is transmitted as an attachment to an electronic transmission.

As such, the system of FIG. 1 allows for improved usability of the sales data stored in the planning information database 106. Through the processing device 104, data manipulation operations can be performed on the requested sales data 116. As discussed in further detail below, the method and apparatus for sales data collaboration further allows for increased usability of sales data with respect to all other forms of sales data, using the collaborative workspace operating on the processing device 104.

FIG. 2 illustrates one embodiment including the input device 102, the processing device 104, the planning information database 106 and the display 110. Similar to the above description of FIG. 1, the processing device 104 receives the input signal 112 and the previous sales data 118 and outputs the viewable data signal 120 to the display 110 using the collaborative workspace operating on the processing device 104. As illustrated in FIG. 2, on the display 110 includes exemplary output display fields for different types of sales data. For example, a first column 130 displays previous planning data, a second column 132 displays current planning data and a third column 134 displays forecasted planning data. In the embodiment where the planning data is sales data, the columns may include previous sales data, current sales data and forecasted sales data.

FIG. 2 illustrates an exemplary output using the planning information database 106 and the exemplary embodiment of sales information disposed therein. For example, the display 110 may include data populated into the fields of columns 130 and 134 with the current sales information column 132 left empty. As recognized by one having ordinary skill in the art, any other suitable data manipulation operation may be performed on the sales information by the processing device 104. Thereupon, the system of FIG. 2 allows for the active display of varying degrees of sales information in a convenient output format dependent upon user data manipulation requests, through the collaborative workspace.

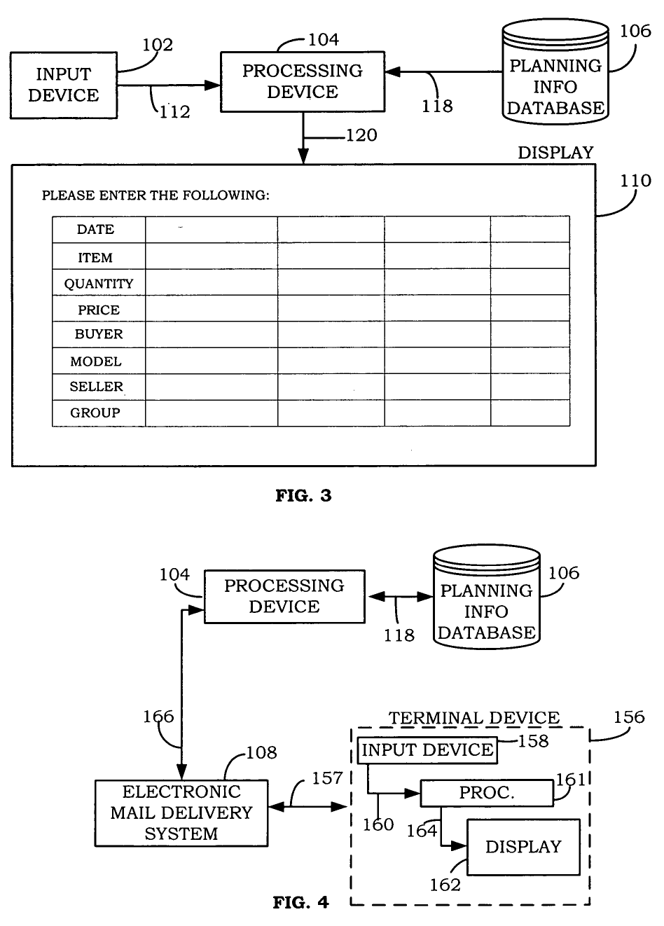

FIG. 3 illustrates one embodiment including the input device 102, the processing device 104, the planning information database 106 and the display 110. Similar to the above-description of FIG. 1, the processing device 104 receives the input signal 112 and the previous sales data 118 and outputs the viewable data signal 120 to the display 110. As illustrated in FIG. 3, on the display 110 includes an exemplary display of a missing planning data form 140. This form 140 may be generated using any known data requesting techniques. Although, the present invention provides for the input information to be portable for other applications or other data manipulation operations.

In one embodiment, this form 140 includes data entry fields for the input of sales information, where the data entry fields include embedded meta-data descriptors relating to the anticipated data entry. The input information may be any suitable sales information, such as current sales information, unrecorded previous sales information and forecasted sales information. In one embodiment, a user may enter the sales information into the form 140 using the input device 102 with updates reflected back to the display 110.

In another embodiment, this form 140 may be transformed, as described above in FIG. 1, and transmitted to a sales person for data collection. The fields may be populated with sales data offline and the form provided back to the processing device 104 such that the sales information is stored in the planning information database 106. In another embodiment, a notification may be sent to a user or group of user (e.g. salespersons) indicating that a form is available on the collaborative workspace awaiting their data entry.

FIG. 4 illustrates a further embodiment including the processing device 104, the planning information database 106 and the electronic mail delivery system 108. The processing device 104 is operative to convert information into recognizable formatting usable and/or transmittable by the electronic mail delivery system 108. The electronic mail delivery system 108 is further in operative communication with a terminal device 156 which may be any suitable device operative to communicate with the electronic mail delivery system 108 using any suitable communication technique including wired or wireless communication with any suitable corresponding communication protocols.

In one embodiment, the terminal device 156 includes an input device 158 for generating input information 160, a processor 161 in operative communication with the input device 158 to receive the input information 160 and a display 162 to receive display information 164 from the processor 160. As recognized by one having ordinary skill in the art, many known elements within the terminal device 156 have been omitted for clarity purposes only.

In one embodiment, the electronic mail delivery system 108 receives a planning data form 166 from the processing device 104. The form 166 may be encoded to be included within an electronic mail communication or may be encoded to be attached to an electronic mail communication. For the form 166 to be included, the form 166 is encoded consistent with native encoding requirements of the electronic mail delivery system 108. For the form 166 to be attached, the form 166 may be encoded in any suitable format independent of the encoding of the electronic mail delivery system 108.

The terminal device 156 is operative to receive the form and output the form on the display 162. An end user may thereupon enter specific information using the input device 158. The processor 161 may thereupon allow for the form, or at least the entered data, to be transmitted back to the processing device 104 through the electronic mail delivery system 108. The data entry into the form using the terminal device 156 may be performed when the terminal device 156 is in direct communication (online) with the electronic mail delivery system 108 and may also be performed when the terminal device 156 is not connected (offline) with the electronic mail delivery system 108. When online, the input information may be transmitted as it is being entered, upon completion of the form 166, or in any other suitable manner. When offline, the completed form may be transmitted when the terminal device 156 becomes online.

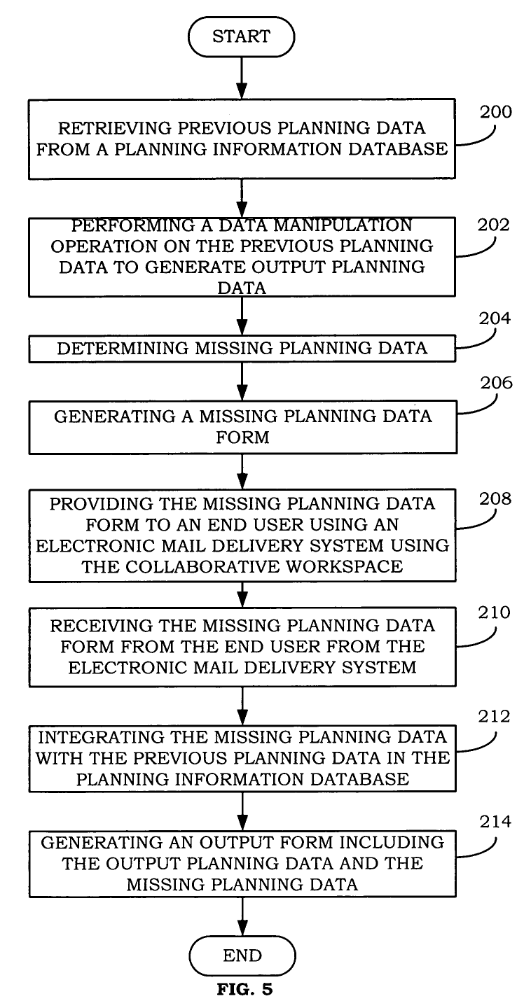

FIG. 5 illustrates one embodiment of a method for collaborating information. A first step, step 200, is retrieving previous planning data from a planning information database. As discussed above, the planning information database 106 includes previous planning data and in the exemplary embodiment of planning data, the previous planning data may be previous planning data. The next step, step 202, is performing a data manipulation operation on the previous planning data to generate output planning data. This step may be performed by the processing device 104 operating the collaborative workspace thereon, in response to a user-input command selecting a data manipulation operation, whereas in the exemplary embodiment of planning data, the output planning data may be output planning data.

The next step, step 204, is determining if there is missing planning data. This missing information may be missing from the planning information database 106 or from any other storage location. Missing planning information may be determined by any suitable means, including but not limited to cross-referencing previous forecasted planning data with current planning information, scanning the planning database for missing data fields or checking a user data collection list to determine if any user has yet submitted planning information. In other embodiments, notifications may be generated where the notifications are provided to team members for data input.

The next step, step 206, is generating a missing planning data form. The missing planning data form may be any suitable form denoting the missing planning information, such as the form 140 illustrated in the display 110 of FIG. 3. In the event specific components of planning information are missing, individual data requests may be generated or the data entry form may be populated with known data fields. Step 208 is providing the missing planning data form to an end user using an electronic mail delivery system using the collaborative workspace. This step may be performed similar to the discussion above relating to FIG. 3. In another embodiment, the spreadsheet itself may be disposed or readily accessible through the collaborative workspace such that users may directly access the spreadsheet and enter the updated information thereon.

The next step, step 210, is receiving the missing planning data form from the end user via the electronic mail delivery system. In one embodiment, the missing planning data form may be completed using the terminal device (156 of FIG. 3) and transmitted back to the processing device (104 of FIG. 3). In one embodiment, between steps 208 and 210, an end user may enter the missing planning data into the form. The data entry may be performed with any suitable input technique, such as but not limited to the exemplary embodiment of the terminal device described above in FIG. 4. Step 212 is integrating the missing planning data with the previous planning data in the planning information database. This step may be performed by the processing device (104 of FIG. 3).

The next step, step 214, is generating an output form including the output planning data and the missing planning data. This step may be performed similar to the discussion above regarding FIG. 1, including a user-input data manipulation command or providing all planning information to the display 110, being performed within and through the collaborative workspace running on the processing device 104. Therefore, one embodiment of the method for collaborating planning information is complete.

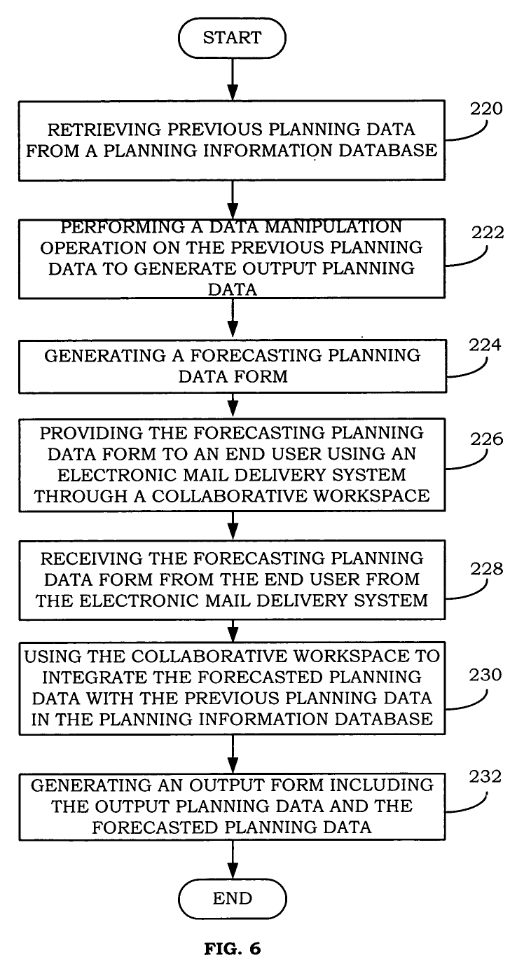

FIG. 6 illustrates another embodiment of a method for collaborating information using planning data. The method begins by retrieving previous planning data from a planning information database, step 220. The next step, step 222, is performing a data manipulation operation on the previous planning data to generate output planning data. In one embodiment, the steps 220 and 222 are similar to the steps 200 and 202 of the method of FIG. 5.

The next step, step 224, is generating a forecasting planning data form. This forecasting planning data form may include multiple data entry fields for planning information, such as the form 140 illustrated on the display 110 of FIG. 3. The form includes multiple fields for data entry of projected planning information. As recognized by one having ordinary skill in the art, the form may include any suitable number of data entry fields similar to or different from a previous planning form, such that planning projections and forecasting operations may be performed.

The next step, step 226, is providing the forecasting planning data form to an end user using an electronic mail delivery system through the collaborative workspace. This step may be performed similar to the above discussion regarding FIG. 3. Step 228 is receiving the forecasted planning data form from the end user from the electronic mail delivery system. Similar to the embodiment discussed above in FIG. 5 with the missing planning data form, the forecasted planning data form may be encoded within or attached to an electronic mail message. In one embodiment, between steps 226 and 228, an end user may enter the forecasting planning data into the form. The data entry may be performed with any suitable input technique, such as but not limited to the exemplary embodiment of the terminal device described above in FIG. 4.

Step 230 is using the collaborative workspace to integrate the forecasted planning data with the previous planning data in the planning information database. The integration of step 230 may be performed by the processing device 104 and the integrated data stored in the planning information database 106. Step 232 is generating an output form including the output planning and the forecasted planning data. This step may be performed similar to the discussion above regarding FIG. 1, including a user-input data manipulation command or providing all planning information to the display 110 through the collaborative workspace 114. Therefore, one embodiment of the method for collaborating planning information is complete.

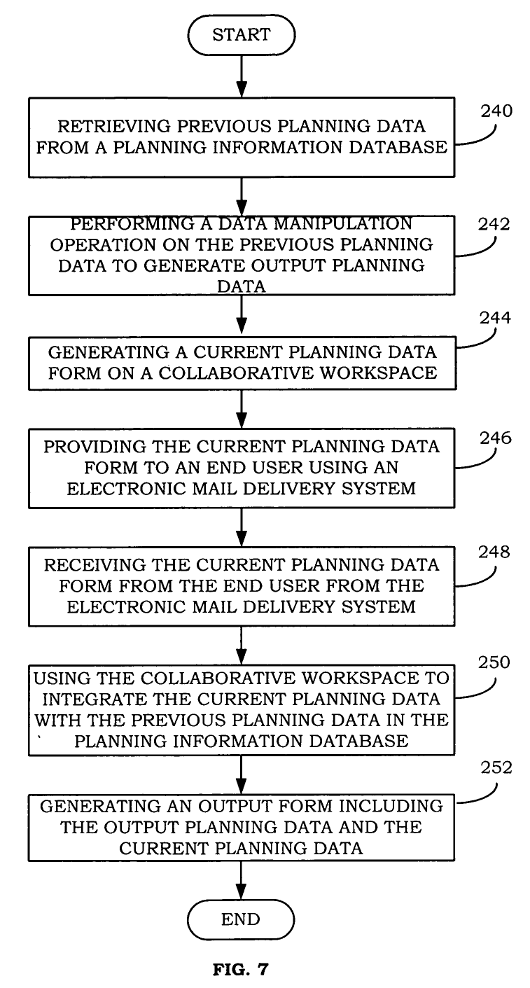

FIG. 7 illustrates another embodiment of a method for collaborating information using the planning data. The method begins by retrieving previous planning data from a planning information database, step 240. The next step, step 242, is performing a data manipulation operation on the previous planning data to generate output planning data. In one embodiment, the steps 240 and 242 are similar to the steps 200 and 202 of the method of FIG. 5.

The next step, step 244, is generating a current planning data form on a collaborative workspace. This current planning data form may include multiple data entry fields for planning information, such as the form illustrated on the display 110 of FIG. 3. The form includes multiple fields for data entry of projected current information. As recognized by one having ordinary skill in the art, the form may include any suitable number of data entry fields similar to or different from the previous planning form and the forecasted planning data form, such that current planning data may be obtained.

The next step, step 246, is providing the current planning data form to an end user using an electronic mail delivery system through the collaborative workspace. This step may be performed similar to the above discussion regarding FIG. 3. Step 248 is receiving the current planning data form from the end user from the electronic mail delivery system. Similar to the embodiment discussed above in FIG. 5 with the missing planning data form, the current planning data form may be encoded within or attached to an electronic mail message. In one embodiment, between steps 246 and 248, an end user may enter the current planning data into the form. The data entry may be performed with any suitable input technique, such as but not limited to the exemplary embodiment of the terminal device described above in FIG. 4.

Step 250 is using the collaborative workspace to integrate the current planning data with the previous planning data in the planning information database. The integration of step 250 may be performed by the processing device 104 and the integrated data stored in the planning information database 106. Step 252 is generating an output form including the output planning and the current planning data through the collaborative workspace. This step may be performed similar to the discussion above regarding FIG. 1, including a user-input data manipulation command or providing all planning information to the display 110. Therefore, one embodiment of the method for collaborating planning information is complete.

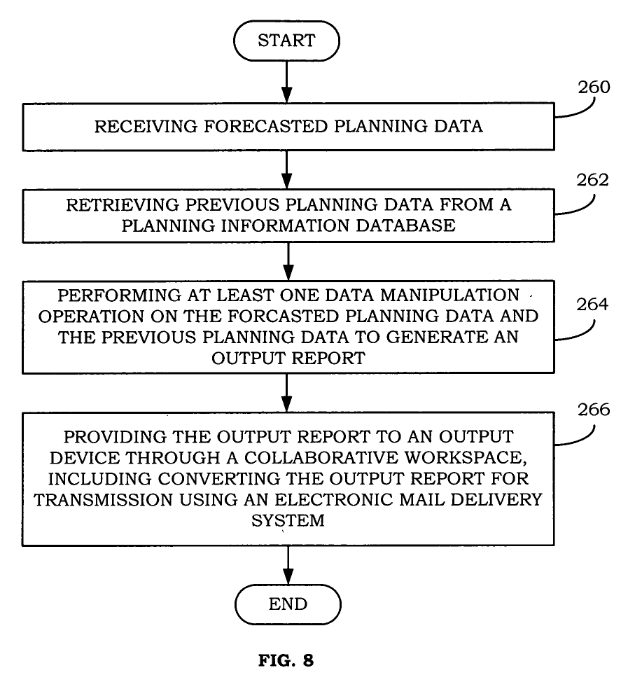

FIG. 8 illustrates another embodiment of a method for collaborating information. This embodiment of the method begins, step 260, with receiving forecasted planning data. In one embodiment, the forecasted planning data may be received from any suitable source such as but not limited to the terminal device described above in FIG. 4. The next step, step 262, is retrieving previous planning data from a planning information database, such as described above with respect to FIG. 1 including the planning information database 106.

The next step, step 264, is performing at least one data manipulation operation on the forecasted planning data and the previous planning data to generate an output report. As discussed above, the data manipulation operation may be any operation allowing for more direct access and/or visibility of source data, such as filtering the data based on filter parameters. The next step, step 266, is providing the output report to an output device through the collaborative workspace, including converting the output report for transmission using an electronic mail delivery system. The output device may be the terminal device 156 of FIG. 4 accessible through the electronic mail delivery system 108.

This embodiment of collaborating planning data provides for the receipt of planning information, generation of an output form including data subject to a data manipulation operation, and outputting the output data for an end user. As such, this embodiment is complete.

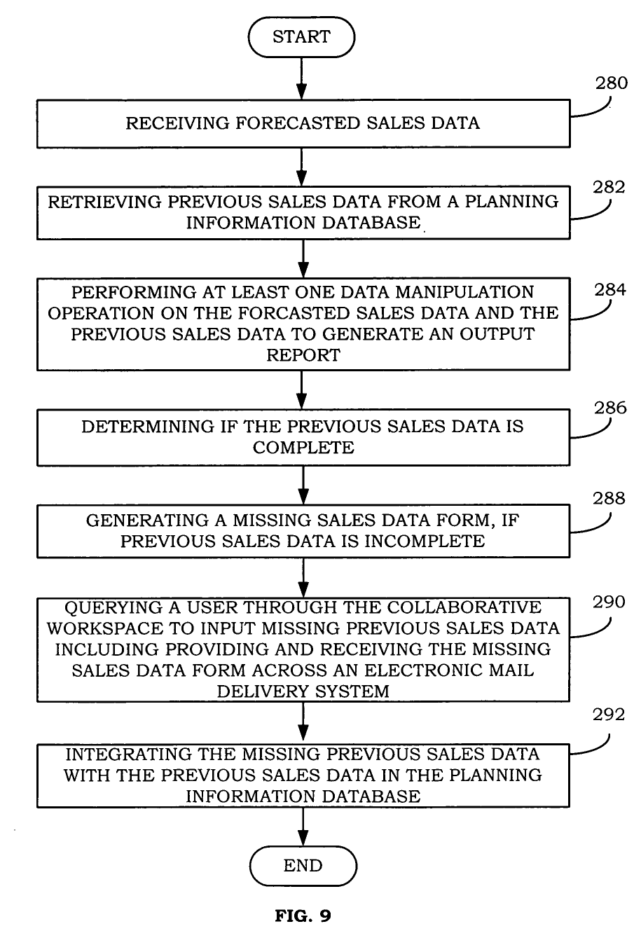

FIG. 9 illustrates an embodiment of collaborating data, such as the exemplary embodiment of sales data, including determining if the data is incomplete. The method begins by receiving forecasted sales data, step 280, retrieving previous sales data from a planning information database, step 282, and performing at least one data manipulation operation on the forecasted sales data and the previous sales data to generate an output report, step 284. In this embodiment, steps 280, 282 and 284 may be similar to steps 260, 262 and 264 of the embodiment of FIG. 8.

The next step, step 286, is determining if the previous sales data is complete. Similar to step 204 in the embodiment of FIG. 5, this determination may be performed using any suitable technique. Whereupon, the next step, step 288, is generating a missing sales data form, if the previous sales data is incomplete. This missing sales data form may be any suitable form, such that the form illustrated in the display 110 of FIG. 3. In another embodiment, rules may be configured using standard rules generating techniques in the collaborative workspace to track and visually indicate which team members have provided data entry during the data retrieval process.

The next step, step 290, is querying a user through the collaborative workspace to input missing previous sales data including providing and receiving the missing sales data form across an electronic mail delivery system. In another embodiment, control mechanisms, such as header or data control mechanisms, associated with the missing sales data form may allow for sending just the sales data instead of the completed form. This step may include an email notification or other notification means. The notification may include a notice that a form is ready on the collaborative workspace for the input of requested information. Step 292 is integrating the missing previous sales data with the previous sales data in the sales information database. As discussed above with other embodiments, the missing previous sales data may be received across the electronic mail delivery system 108 and the sales information stored in the sales information database 106. As such, the sales information database includes the forecasted sales information and complete previous sales information. This sales information may then be subject to one or more data manipulation operations, allowing for a high degree of flexibility with the sales information. Therefore, this embodiment of the method for collaborating sales information is complete.

As such, collaborating sales information provides greater user access and ability to more effectively utilize important sales information. Through central storage of sales information, form generation, and input reception of sales information, sales data may be readily used for analysis. The collaborative workspace provides a single resource for reporting, accessing and integrating the sales information data on a standard central platform. The central storage also allows for versioning of documents, access control and checking documents in and out. A system can quickly and effectively manipulate sales information, including previous, current and forecasted sales information. Through a processing device, gaps in the sales information may be detected and corrected. The missing sales information is updated to provide a broader scope of the sales data and a more accurate reflection of the status of sales. Moreover, through the central storage, redundant operations for data gathering may be eliminated and improvements in user efficiency may be realized through the data retrieval and storage process.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exists implementations of other variations and modifications of the invention and its various aspects, as may be readily apparent to those of ordinary skill in the art, and that the invention is not limited by specific embodiments described herein. For example, the sales information may contain varying data fields for varying types of items, such as tiered pricing structures, special order items, currency conversion fields, conditional sales fields or any other type of data structure allowing for collaboration of sales. It is therefore contemplated to cover any and all modifications, variations or equivalents that fall within the scope of the basic underlying principals disclosed and claimed herein.

What is claimed is:

1. An apparatus for collaborating information, the apparatus comprising:
a planning information database having planning information stored therein; and
a processing device in operative communication with the planning information database, the processing device, in response to executable instructions, operative to:
retrieve previous planning data from the planning information database;
generate an output form including output planning data;
provide the output form to a collaborative workspace; and
notify a user of the status of the output form through the collaborative workspace.

2. The apparatus of claim 1, the processing device further operative to:
determine missing planning data from the planning information database;
generate a missing planning data form;
provide the missing planning data form to the collaborative workspace; and
notify the user of the missing planning data form in the collaborative workspace.

3. The apparatus of claim 2, the processing device further operative to:
receive missing planning data from the user; and
incorporate the missing planning data into the missing planning data form in the collaborative workspace.

4. The apparatus of claim 3 the processing device further operative to:
integrate the missing planning data with the previous planning data; and
store the missing planning data with the previous planning data in the planning information database wherein each of the output form and the missing planning data form include at least one data field, each of the at least one data fields includes meta-data directed to describing the content information stored therein.

5. The apparatus of claim 2, the processing device further operative to:
notify the user of the missing planning data form using an electronic mail delivery system.

6. The apparatus of claim 1, the processing device further operative to:
generate a forecasting planning data form;
provide the forecasting planning data form for the entry of forecasting planning data; and
receive, through the collaborative workspace, the forecasting planning data form having the forecasted planning data disposed therein.

7. The apparatus of claim 6, the processor further operative to:
integrate the forecasted planning data with previous planning data in the planning information database.

8. The apparatus of claim 6, the processor further operative to:
provide the forecasting planning data form using an electronic mail delivery system; and
receive, through the collaborative workspace, the forecasting planning data form having the forecasted planning data from the electronic mail delivery system wherein each of the output form and the forecasting planning data form include at least one data field, each of the at least one data fields includes meta-data directed to describing the content information stored therein.

9. The apparatus of claim 1, the processor further operative to:
generate a current planning data form;
provide the current planning data form for the entry of the current planning data; and
receive, through the collaborative workspace, the planning data input form having the current planning data disposed therein.

10. The apparatus of claim 9, the processor further operative to:
integrate the current planning data with previous planning data in the planning information database.

11. The apparatus of claim 9, the processor further operative to:
provide the planning data input form using an electronic mail delivery system; and
receive the planning data input form having the current planning data using an electronic mail delivery system wherein each of the output form and the current planning data form include at least one data field, each of the at least one data fields includes meta-data directed to describing the content information stored therein.

12. A method for collaborating information, the method comprising:
retrieving previous planning information from the planning information database;
generating an output form including output planning information;
providing the output form to a collaborative workspace; and
notifying a user of the status of the output form through the collaborative workspace.

13. The method of claim 12, the method further comprising:
determining missing planning data from the planning information database;
generating a missing planning data form;
providing the missing planning data form to the collaborative workspace; and
notifying the user of the missing planning data form in the collaborative workspace.

14. The method of claim 13 further comprising:
receiving missing planning input data from the user; and
incorporating the missing planning data into the missing planning data form in the collaborative workspace.

15. The method of claim 14 further comprising:
integrating the missing planning data with previous planning data; and
storing the missing planning data with the previous planning data in the planning information database wherein each of the output form and the missing planning data form include at least one data field, each of the at least one data fields includes meta-data directed to describing the content information stored therein.

16. The method of claim 14 further comprising:
notifying the user of the missing planning data form using an electronic mail delivery system.

17. The method of claim 12, the method further comprising:
generating a forecasting planning data form;
providing the forecasting planning data form for the entry of forecasting planning data; and
receiving, through the collaborative workspace, the forecasting planning data form having the forecasted planning data disposed therein.

18. The method of claim 17 further comprising:
integrating the forecasted planning data with previous planning data in the planning information database.

19. The method of claim 17 further comprising:
providing the forecasting planning data form using an electronic mail delivery system; and
receiving, through the collaborative workspace, the forecasting planning data form having the forecasted planning data from the electronic mail delivery system wherein each of the output form and the forecasted planning data form include at least one data field, each of the at least one data fields includes meta-data directed to describing the content information stored therein.

20. The method of claim 12, the method further comprising:
generating a current planning data form;
providing the current planning data form for the entry of the current planning data; and
receiving, through the collaborative workspace, the planning data input form having the current planning data disposed therein.

21. The method of claim 20 further comprising:
integrating the current planning data with previous planning data in the planning information database.

22. The method of claim 20 further comprising:
providing the planning data input form using an electronic mail delivery system; and
receiving the planning data input form having the current planning data using an electronic mail delivery system wherein each of the output form and the current planning data form include at least one data field, each of the at least one data fields includes meta-data directed to describing the content information stored therein.
